(19) United States
(12) Patent Application Publication
(10) Pub. No.: US 2017/0203456 A1
(43) Pub. Date: Jul. 20, 2017

(54) CUTTING DEVICE FOR CUTTING TIRE COMPONENTS

(71) Applicant: VMI HOLLAND B.V., Epe (NL)

(72) Inventor: Gerardus Johannes Catharina Van Laar, Epe (NL)

(21) Appl. No.: 15/324,010

(22) PCT Filed: Jun. 3, 2015
(86) PCT No.: PCT/NL2015/050398

§ 371 Date: Jan. 5, 2017

(30) Foreign Application Priority Data
Jul. 9, 2014 (NL) 2013158

(51) Int. Cl. B26D 3/00; B26D 7/00; B26D 1/00; B26D 1/45

(52) U.S. Cl. CPC B26D 3/005; B26D 1/455; B26D 7/0006; B26D 1/0006; B26D 2001/006; B26D 2001/0066

(57) ABSTRACT

A cutting device for cutting tire components. The cutting device includes an upper cutting member and a lower cutting member. The upper cutting member is arranged to be moved in a cutting plane along the lower cutting member to cut the tire component in cooperation with the lower cutting member along a cutting line. The upper cutting member includes an upper knife with an upper cutting edge that is convexly arcuate in the cutting plane with respect to the lower cutting member. The upper cutting member is arranged to be moved with the arcuate upper cutting edge thereof along the lower cutting member in a rocking motion in the cutting plane. The arcuate upper cutting edge has a radius and a rotation center for the rocking motion at the origin of the radius, wherein the rotation center is located outside the upper cutting member.

### CROSS REFERENCE TO RELATED APPLICATIONS

This application is the U.S. National Phase Application of PCT/NL2015/050398, filed Jun. 3, 2015, which claims priority to Netherlands Patent Application No. 2013158, filed Jul. 9, 2014, the contents of such applications being incorporated by reference herein.

### FIELD OF THE INVENTION

The invention relates to a cutting device for cutting tire components.

### BACKGROUND

Cutting devices for cutting tire components are known in two types; guillotine cutters or disc and bar cutters. Guillotine cutters comprise an upper knife and a lower knife, each with linear cutting edges. The upper knife is moved vertically along the lower knife to make a cut in a tire component. In guillotine cutters, the cutting angle of the upper knife with respect to the lower knife is generally very small. Due to the minimal cutting angle, the pressure of the upper knife is mainly directed downwards. A large portion of the upper knife is in contact with the tire component at once. The forces involved with such downwards cutting of a tire component are relatively large and may cause the upper knife to deform, thereby resulting in an inconsistent cutting gap between the upper knife and the lower knife. The knifes of a guillotine cutter are typically reinforced or constructed out of heavy material to increase the stiffness and to counter these forces. The downwardly directed cutting forces may further deform the material of the tire component to be cut.

Disc and bar cutters comprise a disc-shaped upper knife and a bar-like lower knife. The disc-shaped upper knife runs in the longitudinal direction along the bar-like lower knife, while rotating over several revolutions to cut the tire component. The disc-shaped upper knife can be designed to be smaller than its guillotine counterpart, while the smaller radius of the disc-shaped upper knife results in a greater cutting angle of the disc-shaped upper knife with respect to the bar-like lower knife. The contact surface between the upper knife and the tire component is considerably smaller and the increased cutting angle reduces the amount of pressure force required for cutting the tire component. The same small radius and the great cutting angle however cause a substantial amount of the pressure force to be directed horizontally, thereby causing deformations in front of the disc-shaped upper knife.

### SUMMARY OF THE INVENTION

According to a first aspect, the invention provides a cutting device for cutting tire components, wherein the cutting device comprises an upper cutting member and a lower cutting member, wherein the upper cutting member is arranged to be moved in a cutting plane along the lower cutting member to cut the tire component in cooperation with the lower cutting member along a cutting line, wherein the upper cutting member comprises an upper knife with an upper cutting edge that is convexly arcuate in the cutting plane with respect to the lower cutting member, wherein the upper cutting member is arranged to be moved with the arcuate upper cutting edge thereof along the lower cutting member in a rocking motion in the cutting plane, wherein the arcuate upper cutting edge has a radius and a rotation center for the rocking motion at the origin of said radius, wherein the rotation center is located outside the upper cutting member.

This allows for the upper cutting member to be moved in a rocking motion about a rotation center that is not limited to the physical extents of the upper cutting member. The radius of the arcuate upper cutting edge can thus be dimensioned to be relatively large with respect to the tire component to be cut. The arcuate upper cutting edge can therefor provide the same advantages as a disc-shaped upper knife of a conventional disc and bar cutter, e.g. reducing the contact surface of the upper knife with the tire component during cutting, while reducing the drawbacks associated with the typically small diameter and large cutting angle of such a convention disc and bar cutter.

In an embodiment the arcuate upper cutting edge has a length that is less than two radians with respect to said radius, most preferably less than one radian with respect to said radius. The small length of the arcuate upper cutting edge with respect to the overall circumference can allow for a compact upper knife with a relatively large radius. The upper knife can thus be more compact or can be provided with a larger radius.

In an embodiment the cutting device comprises a guide member for guiding the rocking motion of the upper cutting member with respect to the lower cutting member. The guide member can improve the stability and repeatability of the rocking motion.

In an embodiment the upper cutting member comprises a first coupling element coupled to the upper knife, wherein the guide member is provided with a first arcuate guide element for receiving and guiding the first coupling element relative to the guide member along a first cycloid path followed by the first coupling element during the rocking motion of the upper cutting member. The interaction between the first coupling element and the first arcuate guide element improves the consistency of the rocking motion along the first cycloid path. Furthermore, the coupling between the first coupling element and the first arcuate guide element prevents that the upper knife shifts in a direction parallel to the cutting line.

In a preferred embodiment thereof the upper cutting member comprises a second coupling element coupled to the upper knife, wherein the guide member is provided with a second arcuate guide element for receiving and guiding the second coupling element relative to the guide member along a second cycloid path followed by the second coupling element during the rocking motion of the upper cutting member. The interaction between the second coupling element and the second arcuate guide element improves the consistency of the rocking motion along the second cycloid path. Furthermore, the coupling between the second coupling element and the second arcuate guide element prevents that the upper knife shifts in a direction parallel to the cutting line.

In an embodiment the first coupling element and the second coupling element are mutually spaced apart, preferably at opposite ends of the upper knife in the direction of the rocking motion. The spacing between the coupling elements further improves the stability of the rocking motion and can allow for other components of the upper cutting member and/or the guide member to be accommodated in the spacing.

In an embodiment the upper knife is symmetrical or substantially symmetrical about the half length of the arcuate upper cutting edge, wherein the first coupling element and the second coupling element are arranged on opposite symmetrical sides of the upper knife. The upper cutting member can thus be moved symmetrically in the rocking motion between the coupling elements and their respective arcuate guide elements.

In an embodiment the cutting device is provided with an actuator for driving the rocking motion of the upper cutting member with respect to the lower cutting member. The rocking motion can thus be actively driven and/or controlled, instead of e.g. a manual actuation.

In an embodiment the actuator is coupled to the upper cutting member at a distance radially spaced apart from the rotation center of the arcuate upper cutting edge. The actuator can thus be placed in a decentralized position, e.g. within the physical boundaries of cutting device, while the rotation center is located outside said physical boundaries.

In an embodiment the rocking motion comprises a rotation of the upper cutting member about the rotation center and a translation of the rotation center parallel to the cutting line, wherein the actuator comprises a carriage that is linearly movable parallel to the cutting line, wherein the carriage is coupled to the upper cutting member and is arranged for driving the translation of the upper cutting member while allowing the rotation of or imposing the rotation onto the upper cutting member about the rotation center. The carriage can be used to both drive the translation of the upper cutting member and either impose or allow the rotation of the upper cutting member.

In an embodiment the guide member comprises a linear guide, wherein the carriage is coupled to the linear guide for guided linear movement parallel to the cutting line. A linear movement can be easily controlled and/or actuated, e.g. by a linear actuator.

In an embodiment the linear guide is arranged in a fixed position with respect to the first arcuate guide element and the second arcuate guide element. The fixed relative positions of the arcuate guide elements and the linear guide can impose a restricted freedom of movement onto the upper cutting member that is both coupled to the arcuate guide elements and indirectly supported on the linear guide by the carriage.

In an embodiment the actuator is further provided with a timing belt for driving the carriage in the translation direction along the linear guide. The timing belt can effectively control the amount of translation of the carriage along the linear guide.

In an embodiment the carriage is coupled to the upper cutting member at a radius of the arcuate upper cutting edge that is normal to the cutting line. Thus, the carriage can be located very near to and/or parallel to the cutting line.

In an embodiment the upper cutting member is slidable with respect to the carriage in a direction tangential to the arcuate upper cutting edge. The upper cutting member can thus be rotated in the tangential direction and/or the direction of the curvature or arc of the arcuate upper cutting edge.

In an embodiment the upper cutting member is provided with an arcuate rail that is coupled to and concentric to the arcuate upper cutting edge, wherein the actuator comprises a guide shoe that is arranged for slidably receiving or engaging the arcuate rail. The guide shoe can support the upper cutting member relative to the carriage at the radial position of the arcuate rail, while allowing for the aforementioned sliding of the arcuate rail, and thus of the upper cutting member, relative to the carriage.

In an embodiment the rocking motion comprises a rotation of the cutting member about a rotation center and a translation of said rotation center parallel to the cutting line, wherein the circumferential speed of the rotation is substantially equal to the translational speed of the translation. This can reduce slip occurring between the upper cutting member and the lower cutting member.

In an embodiment the upper cutting member overlaps the lower cutting member parallel to or in the cutting plane in a direction normal to the cutting line. The overlap can improve the quality of the cutting.

In an embodiment thereof the overlap between the upper cutting member and the lower cutting member defines a cutting depth, wherein the cutting depth is arranged to remain constant during the rocking motion. As the cutting depth remains constant, the cutting angle can be kept relatively constant as well. This can improve the consistency of the pressure forces occurring between the upper cutting member, the lower cutting member and/or the tire component during the cutting.

In an embodiment the upper cutting member intersects with the lower cutting member at the overlap at a cutting angle that is less than ten degrees, preferably less than five degrees. The small cutting angle can reduce the amount of pressure force being exerted by the upper cutting member on the tire component in a direction parallel to the cutting line, thereby reducing deformations as a result of said pressure force.

In an embodiment the lower cutting member comprises a lower knife, preferably a bar-like lower knife, with a rectilinear lower cutting edge.

In an embodiment the lower cutting member is arranged to be positioned with its rectilinear lower cutting edge extending horizontally or substantially horizontally.

In an embodiment the arcuate upper cutting edge is a segment of a circle. The circularity of the arcuate upper cutting edge can improve the consistency of the cutting angle throughout the cutting.

According to a second aspect, the invention provides a method for cutting tire components with the use of the cutting device according to any one of the preceding claims, wherein the method comprises the step of moving the upper cutting member with the arcuate upper cutting edge thereof along the lower cutting member in a rocking motion in the cutting plane.

Again, the arcuate upper cutting edge can provide the same advantages as a disc-shaped upper knife of a conventional disc and bar cutter, e.g. reducing the contact surface of the upper knife with the tire component during cutting, while reducing the drawbacks associated with the typically small diameter and large cutting angle of such a convention disc and bar cutter. In particular, the small length of the arcuate upper cutting edge with respect to the overall circumference can allow for a compact upper knife with a relatively large radius.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 show a front view of the cutting device according to the invention;

FIG. 2 show a cross sectional side view of the cutting device according to the line II-II in FIG. 1; and

FIGS. 3 and 4 show front views of the cutting device in two operational positions according to the invention.

### DETAILED DESCRIPTION OF THE INVENTION

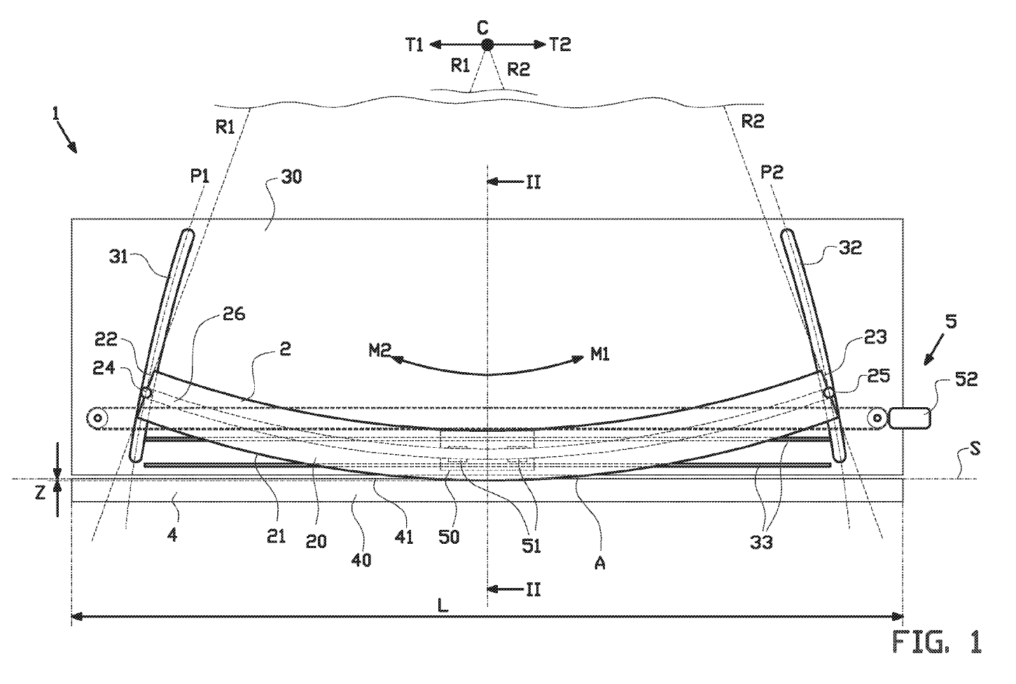

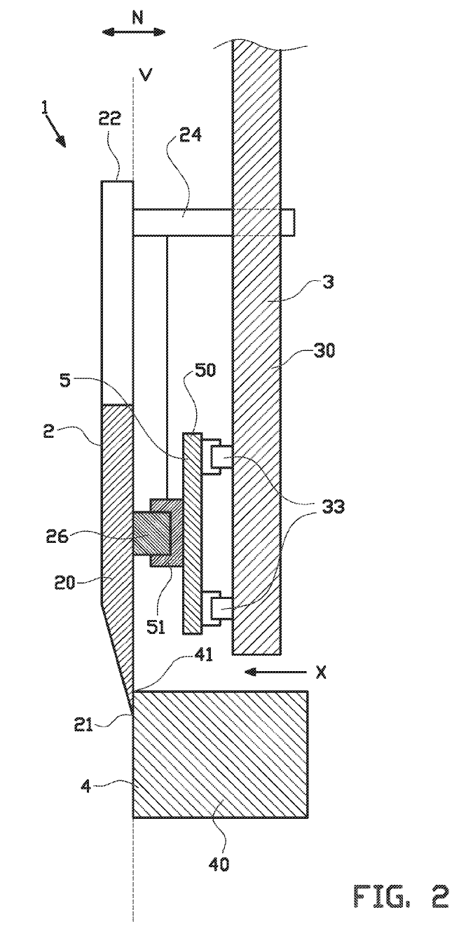

FIGS. 1 and 2 show a cutting device 1 for cutting tire components according to an exemplary embodiment of the invention.

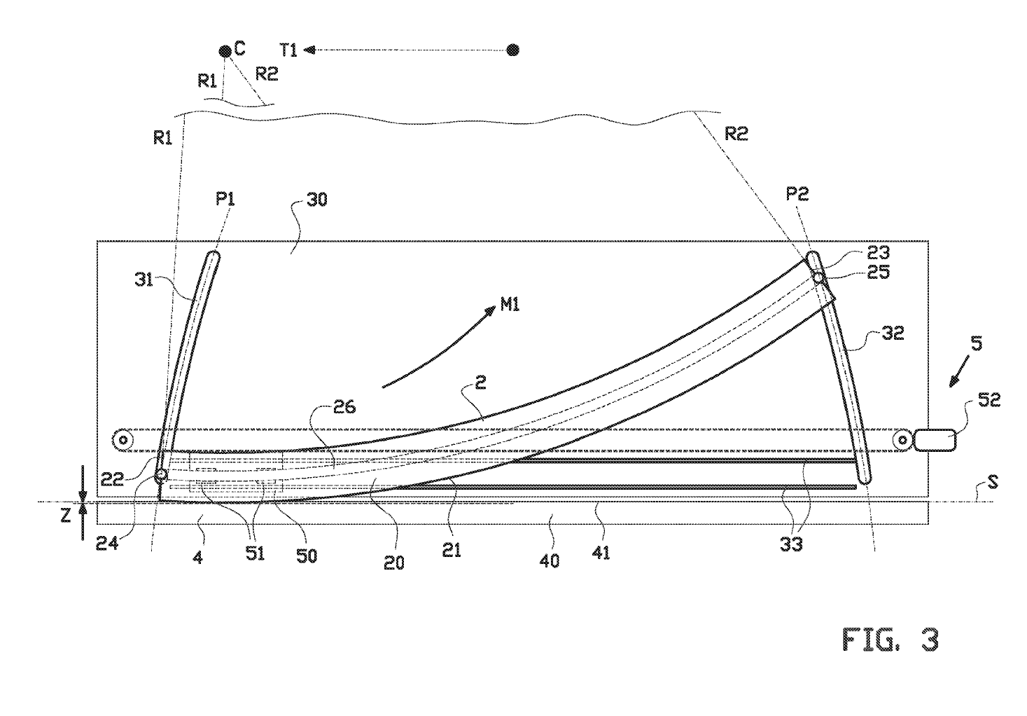

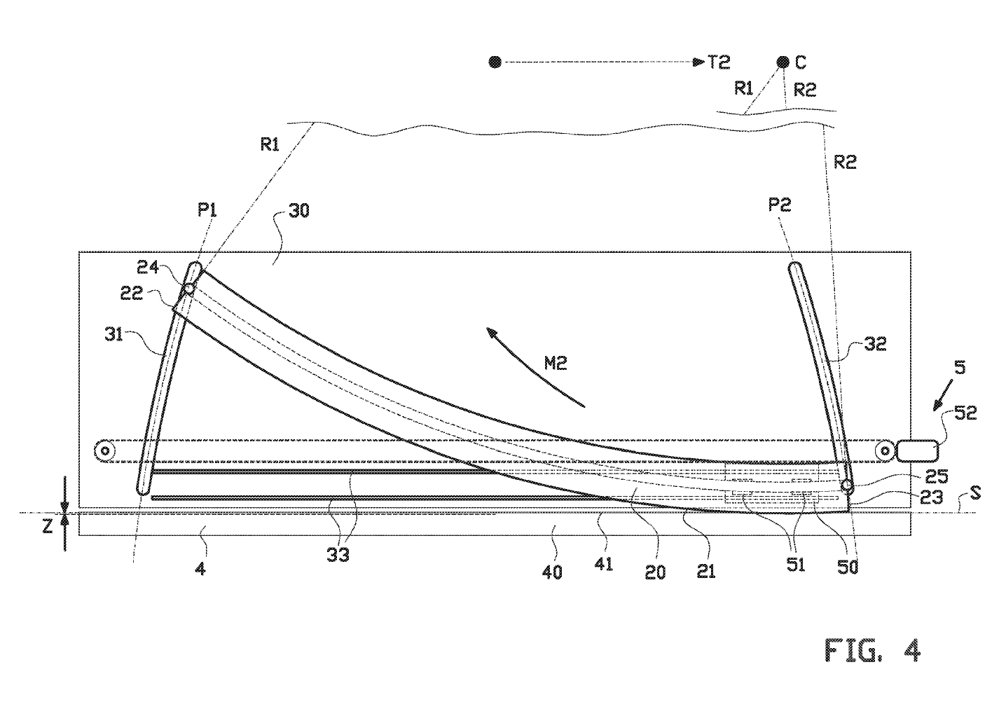

The cutting device 1 comprises an upper cutting member 2, a guide member 3, a lower cutting member 4 and an actuator 5. As shown in FIG. 2, the upper cutting member 2 is movable in a cutting plane V along the lower cutting member 4 for cutting one or more of the tire components in cooperation with the lower cutting member 4. Preferably, as in FIGS. 1 and 2, the cutting device 1 is carefully positioned on a factory floor such that the movement of the upper cutting member 2 is a movement in a vertical or substantially vertical cutting plane V. As best seen in FIGS. 3 and 4, the upper cutting member 2 is arranged to be moved in a reciprocating rolling or rocking motion along the lower cutting member 4 in a manner that will be specified hereafter.

The upper cutting member 2 comprises an upper knife 20 with an upper cutting edge 21 extending between a first end 22 and a second end 23 of the upper knife 20. The upper cutting edge 21, when projected in a normal direction N onto the cutting plane V, is curved or arcuate. The curvature or arc of the upper cutting edge 21 convexly faces the lower cutting member 4, meaning that its radial outer side is facing towards the lower cutting member 4 in the cutting plane V or a direction parallel to the cutting plane V. In this exemplary embodiment, the curvature or arc of the arcuate upper cutting edge 21 is a segment of a virtual circle. As such, the curvature or arc of the arcuate upper cutting edge 21 has constant radii R1, R2 between the ends 22, 23 of the upper knife 20 and a rotation center C at the origin of said radii R1, R2. The radii R1, R2 are considerably larger, preferably at least a factor of five and most preferably at least a factor of ten, than the radius of the cutting disc of a conventional disc and bar cutter. In the figures, the radii R1, R2 are schematically shortened by break lines to save space in the drawings.

Alternatively, the curvature or arc can be a segment of an ellipsoid or a segment of another curvature, in which case the upper cutting edge has at least two points with radii R1, R2 that intersect in a rotation center C. An ellipsoid segment is less favorable because of the varying radii along the length of the segment, which causes a varying pressure force when the segment runs over the tire component.

In this exemplary embodiment, the radially inner edge of the body of the upper knife 20 is concentrically formed with respect to the arc of the arcuate upper cutting edge 21, such that the contour of the upper knife 20 resembles a segment of an annulus or ring with a limited radial thickness. In particular, it can be observed that the body of the knife 20 does not extend up to or intersect with the rotation center C of the arc or that the rotation center C is located outside the body 20 of the upper knife 20. At least one of the sides of the body of the upper knife 20, in particular the side facing away from the cutting plane V and the lower cutting member 4, is provided with a beveled face tapering towards the arcuate upper cutting edge 21.

As shown in FIG. 1, the arcuate upper cutting edge 21 has a length L between the ends 22, 23 of the upper knife 20 that is less than two radians, and preferably less than one radian with respect to the radii R1, R2. In this exemplary embodiment, the length L of the arcuate upper cutting edge 21 is approximately 0.6 to 0.7 radians with respect to the radii R1, R2.

The upper cutting member 2 further comprises a first coupling element 24 and a second coupling element 25 coupled to the body of the upper knife 20 at or near the respective first end 22 and second end 23. In particular, the upper knife 20 is symmetrical or substantially symmetrical with respect to the halfway point of the length L of the arcuate upper cutting edge 21, wherein the first coupling element 24 and the second coupling element 25 are arranged on opposite symmetrical sides of the upper knife 20. In this exemplary embodiment, the coupling elements 24, 25 are in the form of pins projecting from the upper knife 20 towards the guide member 3.

As shown in FIGS. 1 and 2, the upper cutting member 2 is further provided with an arcuate rail 26 that is coupled to the side of the knife body of the upper knife 20 that faces towards the cutting plane V and/or the guide member 3. The arcuate rail 26 extends at the same curvature or arc or is concentric to the arcuate upper cutting edge 21. In this exemplary embodiment, the arcuate rail 26 is positioned radially in the middle of the radial thickness of the knife body of the upper knife 20. The arcuate rail 26 extends along a substantial part of the length L and preferably the entire length L of the upper knife 20.

As best seen in FIG. 1, the guide member 3 comprises a guide plate 30 extending behind the upper cutting member 2 and above the lower cutting member 4. As shown in FIG. 2, the guide plate 30 extends parallel to the cutting plane V. The guide member 3 is provided with a first arcuate guide element 31 and a second arcuate guide element 32 in the form of separate slots in the guide plate 30. The first arcuate guide element 31 and the second arcuate guide element 32 extend along a first cycloid path P1 defined or followed by the first coupling element 24 and a second cycloid path P2 defined followed by the second coupling element 25 as these coupling elements 24, 25 move or travel relative to the guide member 3 as a result of the rocking motion of the upper cutting member 2 relative to said guide member 3. The first arcuate guide element 31 and the second arcuate guide element 32 are arranged for receiving, engaging and/or guiding the first coupling element 24 and the second coupling element 24, respectively, along their respective cycloid paths P1, P2.

Alternatively, the arcuate guide elements 31, 32 may be formed as ridges (not shown) extending along the respective cycloid paths P1, P2 and the coupling elements 24, 25 may be formed as hooks (not shown) hooking behind or engaging with the ridges of the respective arcuate guide elements 31, 32.

As shown in FIG. 1, the guide member 3 further comprises a linear guide 33, preferably in the form of a set of parallel rails, which extends parallel to the cutting line V in or along the guide plate 30 and between the arcuate guide elements 31, 32. The linear guide 33 is located at the bottom of the guide plate 30, near the lower cutting member 4 and intersects with the guide rail 26 of the upper knife 20 when viewed in the normal direction N of the cutting plane V. The mutual positions of the linear guide 33 with respect to the first arcuate guide element 31 and the second arcuate guide element 32 are fixed, at least during the cutting.

As shown in FIG. 2, the upper cutting member 2 and the lower cutting member 4 are arranged at opposite sides of the cutting plane V. The lower cutting member 4 comprises a lower, bar-like knife 40 with an elongate, bar-like body extending parallel to and in close proximity to the cutting plane V. The lower knife 40 is provided with a rectilinear lower cutting edge 41 facing the upper knife 20 at the opposite side of the cutting plane V. The lower cutting edge 41 defines a rectilinear cutting line S along which the tire components are cut. The cutting device 1, and in particular the lower cutting member 4, is arranged to be positioned relative to a factory floor such that the rectilinear lower cutting edge 41 extends horizontally or substantially horizontally.

During the cutting, the upper knife 20 overlaps the lower knife 40 parallel to and/or in the cutting plane V in a vertical direction normal or perpendicular to the cutting line S. In particular, the arcuate upper cutting edge 21 intersects with the rectilinear lower cutting edge 41 at the cutting line S and overlaps said lower cutting edge 41 by a cutting depth Z. The cutting depth Z is arranged to remain constant during the rocking motion. The angle between the arcuate upper cutting edge 21 and the rectilinear lower cutting edge 41 at the intersection or cutting point between the cutting edges 21, 41 defines a cutting angle A. The cutting angle A is less than ten degrees, and preferably even less than five degrees.

The actuator 5 comprises a carriage 50 that is movably mounted on or coupled to the linear guide 33 of the guide member 3 so as to be slidable or movable along the linear guide 33 in a translation T1, T2 parallel to the cutting line S. The actuator 5 is provided with two guide shoes 51 which are coupled to the carriage 50 to move in translation T1, T2 in unison with the carriage 50 along the linear guide 33. The guide shoes 51 are arranged for slidably receiving and/or engaging the arcuate guide rail 26 of the upper cutting member 2 at a radius of the arcuate guide rail 26 and/or the arcuate upper cutting edge 21 that is normal to the cutting line S. The guide shoes 51 are arranged for supporting the upper cutting member 2 relative to the carriage 50 and/or the lower cutting member 4 at a constant cutting depth Z. At the point where the guide shoes 51 interact with said arcuate guide rail 26, the guide shoes 51 are placed in an orientation tangential to the curvature or arc of the arcuate guide rail 26 for allowing a sliding movement of the arcuate guide rail 26 through the guide shoes 51 and relative to the carriage 50 in a direction tangential to or in the curvature or arc of the arcuate guide rail 26 and/or the arcuate upper cutting edge 21. With the use of the guide shoes 51, the carriage 50 can thus be coupled to the upper cutting member 2 at the arcuate guide rail 26 thereof, while allowing a sliding rotation M1, M2 of the upper cutting member 2 relative to the carriage 50 about the rotation center C of the arcuate upper cutting edge 21.

As shown in FIG. 1, the actuator 5 further comprises a timing belt 52 that is mounted to the guide member 3 and extends along the linear guide 33. The timing belt 52 is coupled to the carriage 50 for driving the carriage 50 in a movement parallel to the cutting line S along the linear guide 33.

The method for cutting a tire component with the use of the aforementioned cutting device 1 will be described hereafter with reference to FIGS. 1-4.

As shown in FIGS. 1 and 2, the upper cutting member 2 is in a neutral position with both ends 22, 23 of the upper knife 20 symmetrically at the same height. From this neutral position, the upper cutting member 2 can be moved in the aforementioned rocking motion to and fro two end positions as shown in FIGS. 3 and 4, respectively. The end positions are defined by the freedom of movement of the coupling elements 24, 25 within the boundaries of the arcuate paths P1, P2.

The rocking motion comprises a combination of the rotation M1, M2 of the upper cutting member 2 about the rotation center C and a translation T1, T2 of the rotation center C parallel to the cutting line S. The translation T1, T2 of the rotation center C is driven by the actuator 5, in particular by the carriage 50 thereof. It can be observed that the carriage 50, during the translation T1, T2, remains vertically below the rotation center C and always engages the upper knife 20 at the radius with respect to the rotation center C that is normal to the cutting line S. The rotation M1, M2 is imposed on the upper cutting member 2 by the driven translation T1, T2, which—through the restricted freedom of movement of the upper cutting member 2 with respect to the arcuate guide elements 31, 32 and the guide shoes 51—is converted into a sliding rotation M1, M2 of the arcuate guide rail 26 through the guide shoes 51 about the rotation center C. Effectively, the carriage 50 pulls the respective ends 22, 23 of the upper knife 20, towards which the carriage 50 is moved in translation T1, T2, downwards.

It is further noted that in the event of a slipless rolling motion, the circumferential velocity or speed of the rotation M1, M2 is substantially equal to the translational velocity or speed of the translation T1, T2.

To initiate the cutting, the upper cutting member 2 is moved in the aforementioned rocking motion to one of the end positions as shown in FIG. 3 or 4, thereby clearing a center area for insertion of a tire component (not shown) between the upper cutting member 2 and the lower cutting member 4 in a horizontal supply direction X. With the tire component inserted between the upper cutting member 2 and the lower cutting member 4, the upper knife 20 of the upper cutting member 2 is rocked in the aforementioned manner to the opposite end position.

As the upper cutting member 2 rocks towards the opposite end position, the intersection of the arcuate upper cutting edge 21 with the linear lower cutting edge 41 at the cutting line S travels in translation T1, T2 while cutting through the tire component. The length of the arcuate cutting edge L is such that the tire component can be fully cut within the rocking motion of the upper cutting member 2, while requiring only a small angle of rotation M1, M2 to affect said rocking motion, e.g. less than 60 angular degrees or preferably even less than 30 angular degrees. Because of the arcuate upper cutting edge 21 being a circular segment and the cutting depth Z remaining constant, the cutting angle A remains constant as well throughout the cutting. The cutting angle A is very small with respect to the cutting angle of a conventional disc and bar cutter. Particularly, the cutting angle A approaches or equals the minimal cutting angle of a conventional guillotine cutter. Due to the small cutting angle A, the pressure forces exerted on the tire component during the cutting are mainly directed downwards, thereby preventing any substantial pressure force to be directed in the horizontal plane. Thus, deformation of the tire component in front of the upper cutting member 2 can be reduced.

Meanwhile, the rocking motion allows for a more gradual distribution of the pressure force and better control of said pressure force during the cutting, thereby allowing for a lighter upper cutting member 2 with respect to the relatively heavy upper knife of a conventional guillotine cutter. The reduced and more constant pressure force also allows for better control of the cutting gap between the cutting members 2, 4.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1. A cutting device for cutting tire components, wherein the cutting device comprises an upper cutting member and a lower cutting member, wherein the upper cutting member is arranged to be moved in a cutting plane along the lower cutting member to cut the tire component in cooperation with the lower cutting member along a cutting line, wherein the upper cutting member comprises an upper knife with an upper cutting edge that is convexly arcuate in the cutting plane with respect to the lower cutting member, wherein the upper cutting member is arranged to be moved with the arcuate upper cutting edge thereof along the lower cutting member in a rocking motion in the cutting plane, wherein the arcuate upper cutting edge has a radius and a rotation center for the rocking motion at the origin of said radius, wherein the rotation center is located outside the upper cutting member.

2. The cutting device according to claim 1, wherein the arcuate upper cutting edge has a length that is less than two radians with respect to said radius.

3. The cutting device according to claim 2, wherein the length of the arcuate upper cutting edge is less than one radian with respect to said radius.

4. The cutting device according to claim 1, wherein the cutting device comprises a guide member for guiding the rocking motion of the upper cutting member with respect to the lower cutting member.

5. The cutting device according to claim 4, wherein the upper cutting member comprises a first coupling element coupled to the upper knife, wherein the guide member is provided with a first arcuate guide element for receiving and guiding the first coupling element relative to the guide member along a first cycloid path followed by the first coupling element during the rocking motion of the upper cutting member.

6. The cutting device according to claim 5, wherein the upper cutting member comprises a second coupling element coupled to the upper knife, wherein the guide member is provided with a second arcuate guide element for receiving and guiding the second coupling element relative to the guide member along a second cycloid path followed by the second coupling element during the rocking motion of the upper cutting member.

7. The cutting device according to claim 6, wherein the first coupling element and the second coupling element are mutually spaced apart at opposite ends of the upper knife in the direction of the rocking motion.

8. The cutting device according to claim, wherein the upper knife is symmetrical about the half length of the arcuate upper cutting edge, wherein the first coupling element and the second coupling element are arranged on opposite symmetrical sides of the upper knife.

9. The cutting device according to claim 1, wherein the cutting device is provided with an actuator for driving the rocking motion of the upper cutting member with respect to the lower cutting member.

10. The cutting device according to claim 9, wherein the actuator is coupled to the upper cutting member at a distance radially spaced apart from the rotation center of the arcuate upper cutting edge.

11. The cutting device according to claim 9, wherein the rocking motion comprises a rotation of the upper cutting member about the rotation center and a translation of the rotation center parallel to the cutting line, wherein the actuator comprises a carriage that is linearly movable parallel to the cutting line, wherein the carriage is coupled to the upper cutting member and is arranged for driving the translation of the upper cutting member while allowing the rotation of or imposing the rotation onto the upper cutting member about the rotation center.

12. The cutting device according to claim 11, wherein the cutting device comprises a guide member for guiding the rocking motion of the upper cutting member with respect to the lower cutting member, wherein the guide member comprises a linear guide, wherein the carriage is coupled to the linear guide for guided linear movement parallel to the cutting line.

13. The cutting device according to claim 5, wherein the cutting device comprises a guide member for guiding the rocking motion of the upper cutting member with respect to the lower cutting member, wherein the guide member comprises a linear guide, wherein the carriage is coupled to the linear guide for guided linear movement parallel to the cutting line, wherein the linear guide is arranged in a fixed position with respect to the first arcuate guide element and/or the second arcuate guide element.

14. The cutting device according to claim 12, wherein the actuator is further provided with a timing belt for driving the carriage in the translation direction along the linear guide.

15. The cutting device according to claim 11, wherein the carriage is coupled to the upper cutting member at a radius of the arcuate upper cutting edge that is normal to the cutting line.

16. The cutting device according to claim 11, wherein the upper cutting member is slidable with respect to the carriage in a direction tangential to the arcuate upper cutting edge.

17. The cutting device according to claim 11, wherein the upper cutting member is provided with an arcuate rail that is coupled to and concentric to the arcuate upper cutting edge, wherein the actuator comprises a guide shoe that is arranged for slidably receiving or engaging the arcuate rail.

18. The cutting device according to claim 1, wherein the rocking motion comprises a rotation of the cutting member about a rotation center and a translation of said rotation center parallel to the cutting line, wherein the circumferential speed of the rotation is substantially equal to the translational speed of the translation.

19. The cutting device according to claim 1, wherein the upper cutting member overlaps the lower cutting member parallel to or in the cutting plane in a direction normal to the cutting line.

20. The cutting device according to claim 19, wherein the overlap between the upper cutting member and the lower cutting member defines a cutting depth, wherein the cutting depth is arranged to remain constant during the rocking motion.

21. The cutting device according to claim 19 or 20, wherein the upper cutting member intersects with the lower cutting member at the overlap at a cutting angle that is less than ten degrees or less than five degrees.

22. The cutting device according to claim 1, wherein the lower cutting member comprises a lower knife, with a rectilinear lower cutting edge.

23. The cutting device according to claim 22, wherein the lower cutting member is arranged to be positioned with its rectilinear lower cutting edge extending horizontally.

24. The cutting device according to claim 1, wherein the arcuate upper cutting edge is a segment of a circle.

25. A method for cutting tire components with the use of the cutting device according to claim 1, wherein the method comprises the step of moving the upper cutting member with the arcuate upper cutting edge thereof along the lower cutting member in a rocking motion in the cutting plane.

26. The cutting device according to claim 13, wherein the actuator is further provided with a timing belt for driving the carriage in the translation direction along the linear guide.
